(19) United States
(12) Patent Application Publication
(10) Pub. No.: US 2025/0113779 A1
(43) Pub. Date: Apr. 10, 2025

(54) Hedge-Trimming Device

(71) Applicant: Robert Smith, JR., Tifton, GA (US)

(72) Inventor: Robert Smith, JR., Tifton, GA (US)

(21) Appl. No.: 18/607,791

(22) Filed: Mar. 18, 2024

Related U.S. Application Data
(60) Provisional application No. 63/588,058, filed on Oct. 5, 2023.

(51) Int. Cl. A01G 3/04; A01G 3/053

(52) U.S. Cl. CPC A01G 3/0417; A01G 3/0535

(57) ABSTRACT

A hedge-trimming device is provided. The device is comprised of a moveable frame with at least one wheel that allows the frame to travel forward, backward, left, and right. The frame preferably has a vertical frame member comprised of at least one spinning blade that is powered by at least one motor. The blade may be positioned on the vertical frame member such that it is parallel with vertical frame member. As a result, the device can be moved left and right wherein the blade produces a straight cut along the front surface of a hedge or other greenery.

### CROSS-REFERENCE TO RELATED APPLICATION

The present application claims priority to, and the benefit of, U.S. Provisional Application No. 63/588,058, which was filed on Oct. 5, 2023, and is incorporated herein by reference in its entirety.

### FIELD OF THE INVENTION

The present invention relates generally to the field of landscaping trimming devices. More specifically, the present invention relates to a hedge-trimming device that provides a rolling trimming device that can easily produce straight cutting lines on a hedge with minimal physical effort. Accordingly, the present disclosure makes specific reference thereto. Nonetheless, it is to be appreciated that aspects of the present invention are also equally applicable to other like applications, devices, and methods of manufacture.

### BACKGROUND

Trimming hedges can often be a challenging and labor-intensive task, particularly when using a standard, manual handheld hedge trimmer. Such devices can make the job quite arduous and time-consuming, especially when dealing with hedges that cover extended lengths. This process requires not only time but also consistent effort and attention to detail to ensure even trimming.

Furthermore, for individuals with limited physical strength or dexterity manual hedge trimmers can be particularly demanding. These individuals might find it difficult to exert the necessary force and control required to effectively trim their hedges. This can lead to uneven growth or poorly maintained hedge lines, which can detract from the overall aesthetic of a garden or outdoor space. In addition, the repetitive motions involved in hedge trimming can also lead to strain and fatigue, particularly in the hands, arms, and back. This physical toll can make hedge trimming an unappealing task for many homeowners, potentially leading to neglect of the hedges, which in turn can result in overgrowth and a decline in the appearance and health of the hedge.

Even for individuals with the required amount of physical strength and dexterity required to use handheld hedge trimmers, a significant challenge lies in achieving a uniformly straight edge along the surface of the hedge. Manual trimmers require a steady hand and an eye for detail, making it difficult to maintain a consistent line or shape. This can be particularly frustrating for those aiming for a polished, manicured look in their landscaping.

Therefore, there exists a long-felt need in the art for an improved trimming device for hedges, shrubs, and other similar greenery. There also exists a long-felt need in the art for a hedge-trimming device. More specifically, there exists a long-felt need in the art for a hedge-trimming device that allows a user to easily trim a hedge (or other greenery) with minimal physical effort. Further, there exists a long-felt need in the art for a hedge-trimming device that allows a user to easily trim a hedge (or other greenery) with minimal physical effort and wherein the device easily produces a straight cut on the hedge.

The subject matter disclosed and claimed herein, in one embodiment thereof, comprises a hedge-trimming device. The device is comprised of a moveable frame with at least one wheel that allows the frame to travel forward, backward, left, and right. The frame preferably has a vertical frame member comprised of at least one spinning blade that is powered by at least one motor. The blade may be positioned on the vertical frame member such that it is parallel to the vertical frame member. As a result, the device can be moved left and right wherein the blade produces a straight cut along the front surface of a hedge or other greenery.

In this manner, the hedge-trimming device of the present invention accomplishes all the foregoing objectives and provides an improved trimming device for hedges, shrubs, and other similar greenery. During use, the device allows a user to easily trim a hedge (or other greenery) with minimal physical effort due to the static nature of the frame and wheels. Further, the device easily produces a straight cut on the hedge via the fixed position of the blade as the device is moved.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hedge-trimming device. The device is comprised of a wheeled frame with at least one blade powered by at least one motor, and at least one fan. The device can be positioned in front of a hedge and can cut the front surface (and/or top and bottom surfaces) of the hedge via the blade. The frame is preferably comprised of at least one vertical frame member. In one embodiment, the frame is also comprised of at least one top frame member and at least one bottom frame member that each forms 90-degree angles with the vertical member of the frame.

The frame is also comprised of at least one wheel that can spin 360 degrees to allow the device to move forward, backward, left, and right while cutting a hedge. In another embodiment, the wheel may only be able to move forward and backward. In one embodiment, the frame has both two-direction wheels (i.e., front and back travel) and 360-degree wheels that allow the device to be moved and transported.

The frame is comprised of at least one blade with at least one cutting edge. The blade preferably rotates 360 degrees during use. The blade may be positioned on the vertical frame member, top frame, and/or bottom frame member, wherein the blade is parallel to each frame member it attaches to. In this manner, the blades can be used to trim the front surface, bottom surface, and/or top surface of a hedge in a uniform, straight manner.

The blade is spun by at least one chain drive powered by at least one motor. The speed of the motor can be controlled via at least one control mechanism such as, but not limited to, a throttle, a lever, a button, etc. In the preferred embodiment, the mechanism is positioned on at least one handle of the frame, wherein the handle can be grasped while using the device to move/control the device.

The device may also be comprised of at least one fan preferably positioned on the bottom surface of the top frame member such that the fan blows downwards toward a ground surface. In this manner, the fan blows cut hedge debris away from the hedge while using the device.

The present invention is also comprised of a method of using the device. First, a device is provided comprised of a frame comprised of at least one blade, at least one motor, and at least one wheel. Then, the motor can be started via a starting mechanism to begin spinning the blade. Then, a user can position the blade such that the blade contacts and cuts the front surface of a hedge or other greenery. Next, a user can move the device left and right along the hedge in order to cut the entire front surface of the hedge in a uniform manner via the blade.

The present invention is also comprised of a second method of using the device. First, a device is provided comprised of a frame comprised of at least one blade, at least one motor, and at least one wheel. Then, the motor can be started via a starting mechanism to begin spinning the blade. Then, a user can position the blade such that the blade contacts and cuts the front surface, bottom surface, and/or top surface of a hedge or other greenery. Next, a user can move the device left and right along the hedge in order to cut the entire front surface, bottom surface, and/or top surface of the hedge in a uniform manner via the blade.

Accordingly, the hedge-trimming device of the present invention is particularly advantageous as it provides an improved trimming device for hedges, shrubs, and other similar greenery. During use, the device allows a user to easily trim a hedge (or other greenery) with minimal physical effort. Further, the device allows a user to easily trim a hedge (or other greenery) with minimal physical effort and easily produces a straight cut on the hedge due to the arrangement of the blade of the device on the frame. In this manner, the hedge-trimming device overcomes the limitations of existing trimming devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a hedge-trimming device of the present invention in accordance with the disclosed architecture;

FIG. 2 illustrates a side view of one potential embodiment of a hedge-trimming device of the present invention in accordance with the disclosed architecture;

FIG. 3 illustrates a rear view of one potential embodiment of a hedge-trimming device of the present invention with the cover removed in accordance with the disclosed architecture;

FIG. 4 illustrates a perspective view of one potential embodiment of a hedge-trimming device of the present invention being used to trim a hedge in accordance with the disclosed architecture;

FIG. 5 illustrates a flowchart of a method of using one potential embodiment of a hedge-trimming device of the present invention in accordance with the disclosed architecture; and

FIG. 6 illustrates a flowchart of a method of using one potential embodiment of a hedge-trimming device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved trimming device for hedges, shrubs, and other similar greenery. There also exists a long-felt need in the art for a hedge-trimming device. More specifically, there exists a long-felt need in the art for a hedge-trimming device that allows a user to easily trim a hedge (or other greenery) with minimal physical effort. Further, there exists a long-felt need in the art for a hedge-trimming device that allows a user to easily trim a hedge (or other greenery) with minimal physical effort and wherein the device easily produces a straight cut on the hedge.

The present invention, in one exemplary embodiment, is comprised of a hedge-trimming device comprised of a wheeled frame with at least one blade powered by at least one motor, and at least one fan. The device can be positioned in front of a hedge and can cut the front surface (and/or top and bottom surfaces) of the hedge via the blade. The frame is preferably comprised of at least one vertical frame member. In one embodiment, the frame is also comprised of at least one top frame member and at least one bottom frame member that each forms 90-degree angles with the vertical member of the frame.

The frame is also comprised of at least one wheel that can spin 360 degrees to allow the device to move forward, backward, left, and right while cutting a hedge. In another embodiment, the wheel may only be able to move forward and backward. In one embodiment, the frame has both two-direction wheels (i.e., front and back travel) and 360-degree wheels that allow the device to be moved and transported.

The frame is comprised of at least one blade with at least one cutting edge. The blade preferably rotates 360 degrees during use. The blade may be positioned on the vertical frame member, top frame, and/or bottom frame member, wherein the blade is parallel to each frame member it attaches to. In this manner, the blades can be used to trim the front surface, bottom surface, and/or top surface of a hedge in a uniform, straight manner.

The blade is spun by at least one chain drive powered by at least one motor. The speed of the motor can be controlled via at least one control mechanism such as, but not limited to, a throttle, a lever, a button, etc. In the preferred embodiment, the mechanism is positioned on at least one handle of the frame, wherein the handle can be grasped while using the device to move/control the device.

The device may also be comprised of at least one fan preferably positioned on the bottom surface of the top frame member such that the fan blows downwards toward a ground surface. In this manner, the fan blows cut hedge debris away from the hedge while using the device.

The present invention is also comprised of a method of using the device. First, a device is provided comprised of a frame comprised of at least one blade, at least one motor, and at least one wheel. Then, the motor can be started via a starting mechanism to begin spinning the blade. Then, a user can position the blade such that the blade contacts and cuts the front surface of a hedge or other greenery. Next, a user can move the device left and right along the hedge in order to cut the entire front surface of the hedge in a uniform manner via the blade.

The present invention is also comprised of a second method of using the device. First, a device is provided comprised of a frame comprised of at least one blade, at least one motor, and at least one wheel. Then, the motor can be started via a starting mechanism to begin spinning the blade. Then, a user can position the blade such that the blade contacts and cuts the front surface, bottom surface, and/or top surface of a hedge or other greenery. Next, a user can move the device left and right along the hedge in order to cut the entire front surface, bottom surface, and/or top surface of the hedge in a uniform manner via the blade.

Accordingly, the hedge-trimming device of the present invention is particularly advantageous as it provides an improved trimming device for hedges, shrubs, and other similar greenery. During use, the device that allows a user to easily trim a hedge (or other greenery) with minimal physical effort. Further, the device allows a user to easily trim a hedge (or other greenery) with minimal physical effort and easily produces a straight cut on the hedge due to the arrangement of the blade of the device on the frame. In this manner, the hedge-trimming device overcomes the limitations of existing trimming devices and methods known in the art.

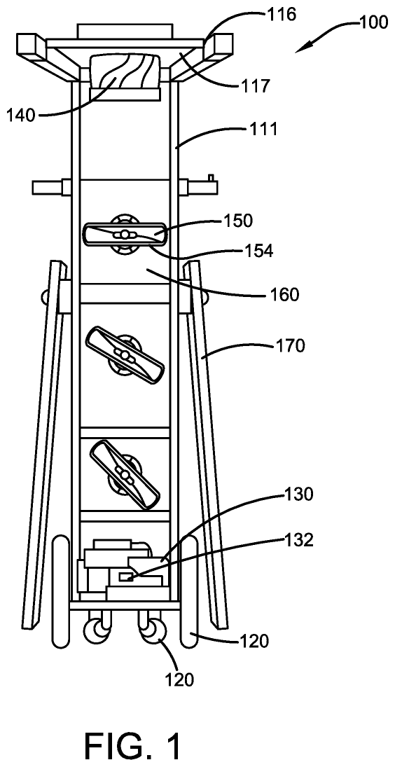

Referring initially to the drawings, FIG. 1 illustrates a front view of one potential embodiment of a hedge-trimming device 100 of the present invention in accordance with the disclosed architecture. The device 100 is comprised of a wheeled frame 110 with at least one blade 150 powered by at least one motor 130, and at least one fan 140. The device 100 can be positioned in front of a hedge 10 and can cut the front surface 11 (and/or top and bottom surfaces 12, 13) of the hedge 10 via the blade 150.

The frame 110 is preferably comprised of at least one vertical frame member 11. In one embodiment, the frame 110 is also comprised of at least one top frame member 116 and at least one bottom frame member 118 that each form 90-degree angles with the vertical member 111 of the frame 110.

The frame 110 is also comprised of at least one wheel 120. The wheel 120 can preferably spin 360 degrees to allow the device 100 to move forward, backward, left, and right while cutting a hedge 10. In this embodiment, the wheel 120 may be comprised of at least one locking mechanism 122 that inhibits total movement of the wheel 120 and/or movement of the wheel in at least one direction. In another embodiment, the wheel 120 may only be able to move forward and backward. In one embodiment, the frame 110 has both two-direction wheels (i.e., front and back travel) and 360-degree wheels that allow the device 100 to be moved and transported. The wheels 120 may be any type known in the art.

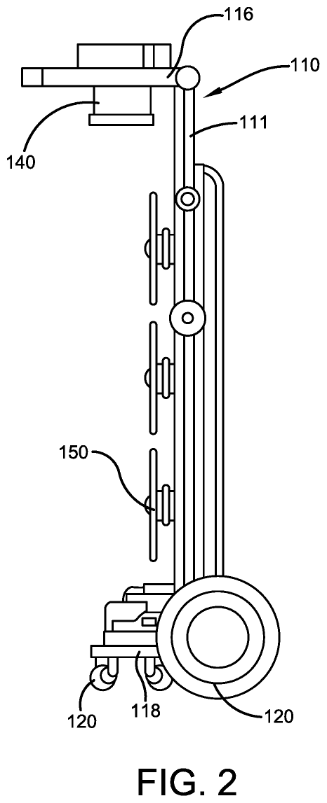

The frame 110 is comprised of at least one blade 150, as also seen in FIG. 2. The blade 150 may be any type of hedge, greenery, landscaping blade, etc., known in the art that may have at least one cutting edge 154. The blade 150 preferably rotates 360 degrees during use. The blade 150 may be positioned on the vertical frame member 111, top frame 116, and/or bottom frame member 118, wherein the blade 150 is parallel with each frame member 111, 116, 118 it attaches to. In this manner, the blades 150 can be used to trim the front surface 11, bottom surface 12, and/or top surface 13 of a hedge 10 in a uniform, straight manner. In one embodiment, the device 100 only has a blade 150 on the vertical member 111 to allow for only cutting/trimming of the front surface 11 of a hedge 10 or other greenery.

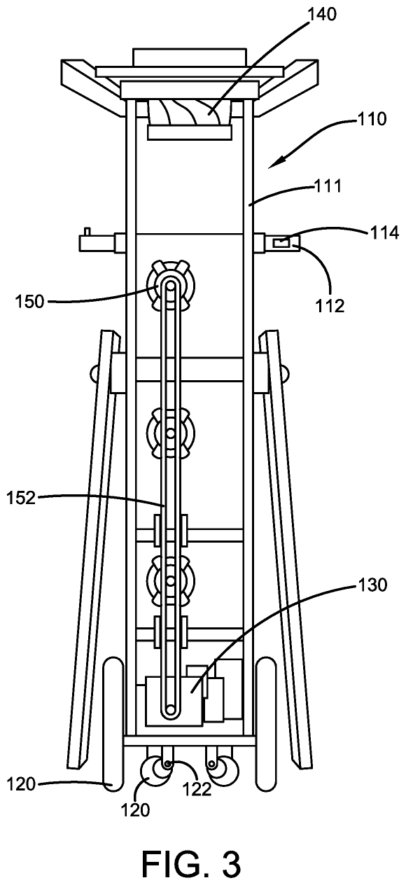

The blade 150 is spun by at least one chain drive 152 powered by at least one motor 130, as seen in FIG. 3. The motor 130 may be any motor type such as, but not limited to, an electric or gas motor. The motor 130 can be started with any starting mechanism 132 such as, but not limited to, a push button, a pull string, etc. The speed of the motor 130 can be controlled via at least one control mechanism 114 such as, but not limited to, a throttle, a lever, a button, etc. In the preferred embodiment, the mechanism 114 is positioned on at least one handle 112 of the frame 110, wherein the handle 112 can be grasped while using the device 100 to move/control the device 100. The mechanism 114 may also allow a user to turn the fan 140 and/or motor 130 on/off.

The device 100 may also be comprised of at least one fan 140. The fan 140 is preferably positioned on the bottom surface 117 of the top frame member 116 such that the fan 140 blows downwards toward a ground surface. In this manner, the fan 140 blows cut hedge 10 debris away from the hedge 10 while using the device 100. The fan 140 may be any fan type such as, but not limited to, an electric or gasoline fan.

The frame 110 may also be comprised of at least one cover 160 that removably or fixedly attaches to the frame 110 and protects a user from debris while cutting a hedge 10. The frame 110 may also be comprised of at least one brace 170 that can be extended from the frame 110 to allow the device 100 to be angled while starting the motor 130.

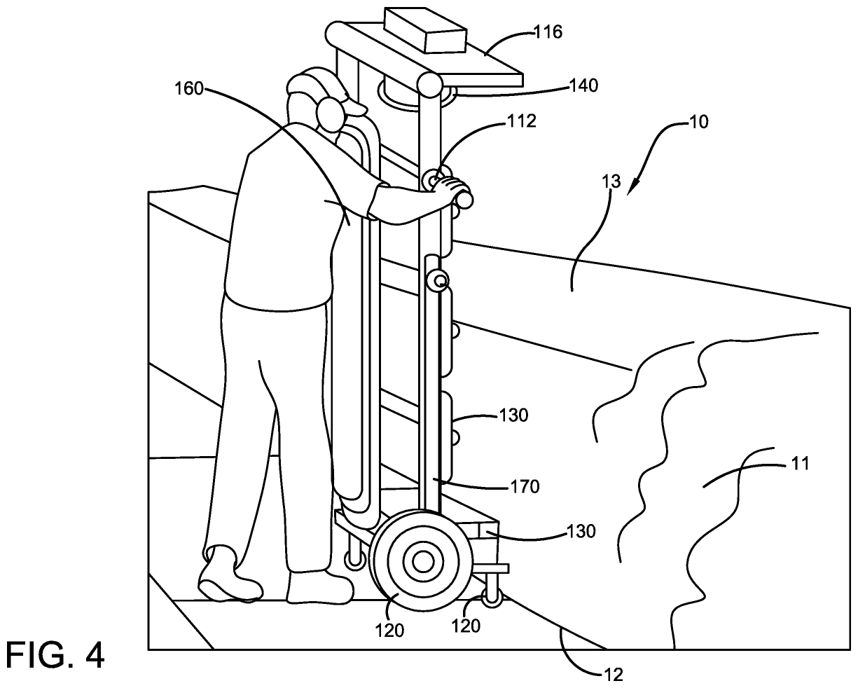

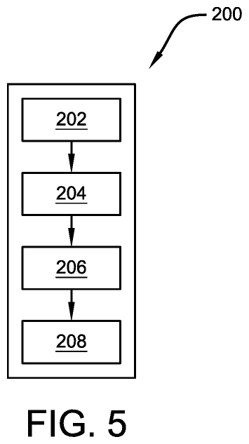

The present invention is also comprised of a method of using 200 the device 100, as seen in FIG. 5. First, a device 100 is provided comprised of frame 110 comprised of at least one blade 150, at least one motor 130, and at least one wheel 120 [Step 202]. Then, the motor 130 can be started via a starting mechanism 132 to begin spinning of the blade 150 [Step 204]. Then, a user can position the blade 150 such that the blade 150 contacts and cuts the front surface 11 of a hedge 10 or other greenery, as seen in FIG. 4 [Step 206]. Next, a user can move the device 100 left and right along the hedge 10 in order to cut the entire front surface 11 of the hedge 10 in a uniform manner via the blade 150 [Step 208].

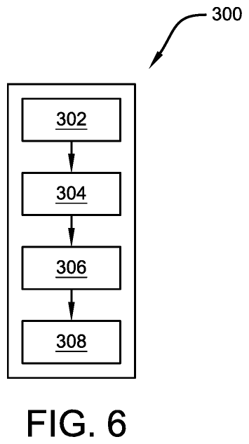

The present invention is also comprised of a second method of using 300 the device 100, as seen in FIG. 6. First, a device 100 is provided comprised of frame 110 comprised of at least one blade 150, at least one motor 130, and at least one wheel 120 [Step 302]. Then, the motor 130 can be started via a starting mechanism 132 to begin spinning of the blade 150 [Step 304]. Then, a user can position the blade 150 such that the blade 150 contacts and cuts the front surface 11, bottom surface 12, and/or top surface 13 of a hedge 10 or other greenery, as seen in FIG. 4 [Step 306]. Next, a user can move the device 100 left and right along the hedge 10 in order to cut the entire front surface 11, bottom surface 12, and/or top surface 13 of the hedge 10 in a uniform manner via the blade 150 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hedge-trimming device” and “device” are interchangeable and refer to the hedge-trimming device 100 of the present invention.

Notwithstanding the foregoing, the hedge-trimming device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the hedge-trimming device 100 as shown in the FIGS. are for illustrative purposes only, and that many other sizes and shapes of the hedge-trimming device 100 are well within the scope of the present disclosure. Although the dimensions of the hedge-trimming device 100 are important design parameters for user convenience, the hedge-trimming device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hedge-trimming device comprising:
a frame comprised of a vertical frame member;
a blade attached to the vertical frame member, wherein the blade is parallel to the vertical frame member;
a motor; and
a first wheel attached to the frame.

2. The hedge-trimming device of claim 1, wherein the first wheel can move in two directions.

3. The hedge-trimming device of claim 1, wherein the first wheel can move 360 degrees.

4. The hedge-trimming device of claim 1, wherein the first wheel is comprised of a locking mechanism.

5. The hedge-trimming device of claim 1 further comprised of a second wheel.

6. The hedge-trimming device of claim 5, wherein the second wheel can move 360 degrees and the first wheel can move in two directions.

7. The hedge-trimming device of claim 1, wherein the frame is comprised of a handle.

8. The hedge-trimming device of claim 1, wherein the motor spins the blade.

9. The hedge-trimming device of claim 8, wherein a speed of the blade is controlled by a control mechanism.

10. The hedge-trimming device of claim 1 further comprised of a fan.

11. The hedge-trimming device of claim 10, wherein the fan is controlled by the control mechanism.

12. A hedge-trimming device comprising:
a frame comprised of a vertical frame member, a top frame member that forms a 90 degree angle with the vertical frame member, and a bottom frame member that forms a 90-degree angle with the vertical frame member;
a first blade attached to the vertical frame member, wherein the blade is parallel to the vertical frame member;
a motor; and
a wheel attached to the frame.

13. The hedge-trimming device of claim 12 further comprised of a second blade that attaches to the top frame member.

14. The hedge-trimming device of claim 12 further comprised of a third blade that attaches to the bottom frame member.

15. The hedge-trimming device of claim 12, wherein the motor spins the blade.

16. The hedge-trimming device of claim 15, wherein a speed of the blade is controlled by a control mechanism.

17. The hedge-trimming device of claim 12 further comprised of a fan.

18. The hedge-trimming device of claim 17, wherein the fan is controlled by the control mechanism.

19. A method of using a hedge-trimming device, the method comprising the following steps:
providing a hedge-trimming device comprised of a frame comprised of a blade, a motor, and a wheel;
starting the motor;
positioning the blade such that the blade contacts and cuts a front surface of a hedge; and
moving the hedge-trimming device left and right along the hedge to cut a front surface of the hedge.

20. The method of using a hedge-trimming device of claim 19, wherein the blade is positioned on a vertical frame member of the frame.
